(19) United States
(12) Patent Application Publication
(10) Pub. No.: US 2013/0335587 A1
(43) Pub. Date: Dec. 19, 2013

(54) TERMINAL DEVICE AND IMAGE CAPTURING METHOD

(71) Applicant: Sony Mobile Communications, Inc., Tokyo (JP)

(72) Inventors: Susumu Takatsuka, Tokyo (JP); Tetsuya Naruse, Kanagawa (JP); Yuji Ide, Kanagawa (JP)

(21) Appl. No.: 13/918,301

(22) Filed: Jun. 14, 2013

Related U.S. Application Data
(60) Provisional application No. 61/659,496, filed on Jun. 14, 2012.

(51) Int. Cl. H04N 5/232

(52) U.S. Cl. CPC H04N 5/23219
USPC 348/211.4

(57) ABSTRACT

An information processing apparatus that acquires image data captured by an image capturing device; detects whether a hand exists in the image data; and controls a state of an image capturing operation performed by the image capturing device in accordance with a command corresponding to at least one of a shape and a gesture of a hand detected in the image data.

### CROSS REFERENCE TO RELATED APPLICATION

The present application claims the benefit of the earlier filing date of U.S. Provisional Patent Application Ser. No. 61/659,496 filed on Jun. 14, 2012, the entire contents of which is incorporated herein by reference.

### BACKGROUND

1. Field of the Disclosure

The present disclosure relates to a terminal device including a camera unit, and an image capturing method applied to the terminal device.

2. Description of Related Art

In recent years, advanced mobile phone terminal devices referred to as smart phones have become widely available. The smart phone includes a camera unit, displays an image captured with the camera unit on a display panel, and stores the image in an internal memory.

On the other hand, some of the terminal devices including the camera unit are developed as those configured to control image capturing based on the detection of a face image included in a captured image. That is, when an image processing unit provided in the terminal device detects the presence of a person's face in an image captured with the camera unit, an optical system of the camera unit brings the face into focus, and the camera unit automatically performs image capturing in a state where the image is focused.

Further, upon being placed on a camera base, which is referred to as a pan tilter, the terminal device having the face image detection function can perform more advanced image capturing. The pan tilter is a rotation base rotating the terminal device thereon in a horizontal direction, and capable of adjusting a tilt angle of the terminal device.

The terminal device mounted on the camera base can automatically search for a subject and perform image capturing. That is, the image processing unit detects a face in a captured image while the camera base adjusts the rotation angle and the tilt angle of the terminal device. Then, the camera unit performs image capturing at the time when the face image is detected.

In Japanese Unexamined Patent Application Publication No. 2011-82913, an image capturing system including a combination of the terminal device and the camera base is disclosed.

### SUMMARY

An image capturing system including a combination of a known terminal device and a known camera base is configured to automatically perform image capturing upon detecting a face image, etc. under a predetermined condition. Therefore, it is difficult for a user to minutely control the image capturing state through a known image capturing system. Specifically, the known image capturing system performs image capturing at the time when the image processing unit detects a smiling face so that an image of the smiling face is automatically captured. Although the automated image capturing has such an advantage that the user is not required to perform a capturing operation, the user does not always capture a satisfactory image, which poses a problem. Specifically, the terminal device, for example, automatically performs image capturing under a predetermined condition, that is, image capturing performed in a picture composition where a person who is being subjected is placed in the center. However, the picture composition that is automatically determined by the system is not always appropriate. Further, the image capturing, which is automatically performed, is not always performed in appropriate timing.

The inventors perceive the need for making a terminal device capture an image based on instructions by a user and establishing an image capturing method for automatically capturing an image.

According to one exemplary embodiment, the disclosure is directed to an information processing apparatus that acquires image data captured by an image capturing device; detects whether a hand exists in the image data; and controls a state of an image capturing operation performed by the image capturing device in accordance with a command corresponding to at least one of a shape and a gesture of a hand detected in the image data.

### BRIEF DESCRIPTION OF DRAWINGS

FIG. 1 is a block diagram illustrating exemplary configurations of a terminal device and a camera base according to an embodiment of the present disclosure.

FIG. 2 is a diagram illustrating exemplary external forms of a terminal device and a camera base according to an embodiment of the present disclosure.

FIGS. 3A and 3B are diagrams illustrating exemplary driven states of the terminal device according to an embodiment of the present disclosure.

FIG. 4 is a flowchart illustrating exemplary control performed during the image capturing according to an embodiment of the present disclosure.

FIG. 5 is a diagram illustrating exemplarily set image capturing mode according to an embodiment of the present disclosure.

FIGS. 6A-6E are diagrams illustrating examples of hand signs and motions that are achieved according to an embodiment of the present disclosure.

FIGS. 7A-7B are diagrams illustrating rotation instructions that are given with hand signs according to an embodiment of the present disclosure.

FIG. 8 is a diagram illustrating exemplary control over image capturing time, which is performed by a hand sign according to an embodiment of the present disclosure.

FIG. 9 is a flowchart illustrating exemplary control performed at the image capturing time according to an exemplary modification of an embodiment of the present disclosure.

FIGS. 10A-10E are diagrams illustrating examples of voices and motions that are achieved according to an exemplary modification of an embodiment of the present disclosure.

FIG. 11 is an explanatory diagram illustrating exemplary control over image capturing time, which is performed by a voice according to an exemplary modification of an embodiment of the present disclosure.

FIGS. 12A-12B are diagrams illustrating a picture composition that is exemplarily set by hand signs according to still another exemplary modification of an embodiment of the present disclosure.

### DETAILED DESCRIPTION

Examples of a terminal device and an image capturing method according to an embodiment of the present disclosure will be described with reference to drawings in the following order.

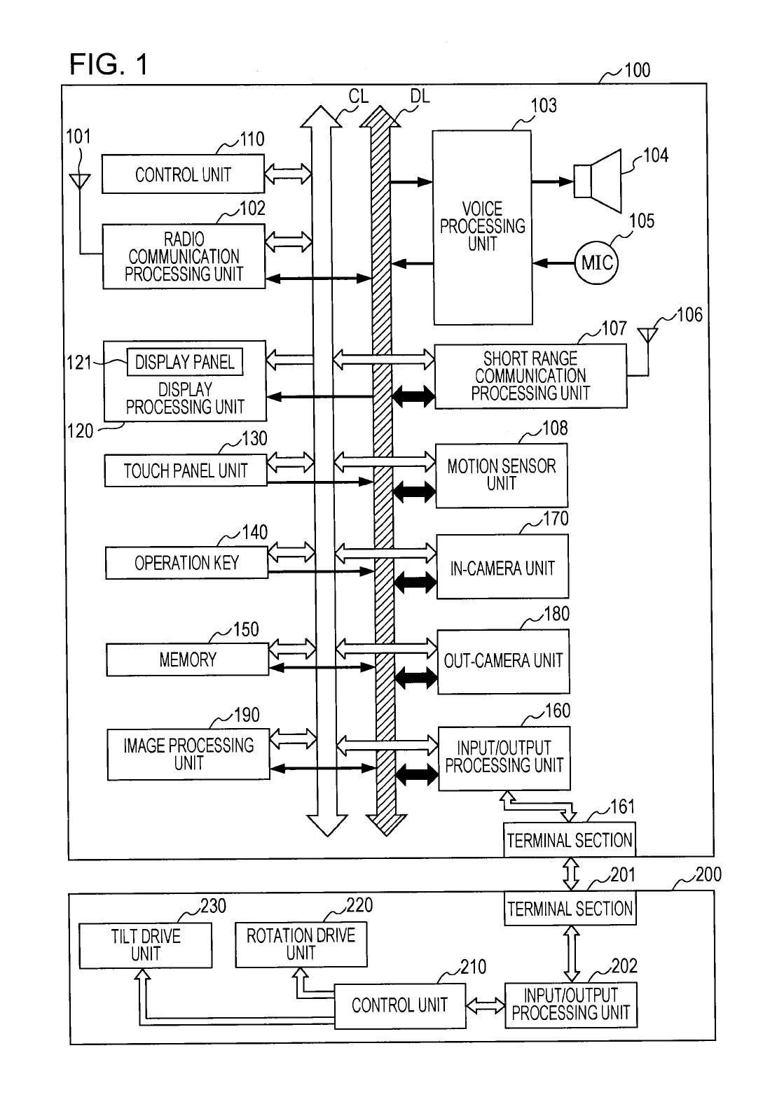

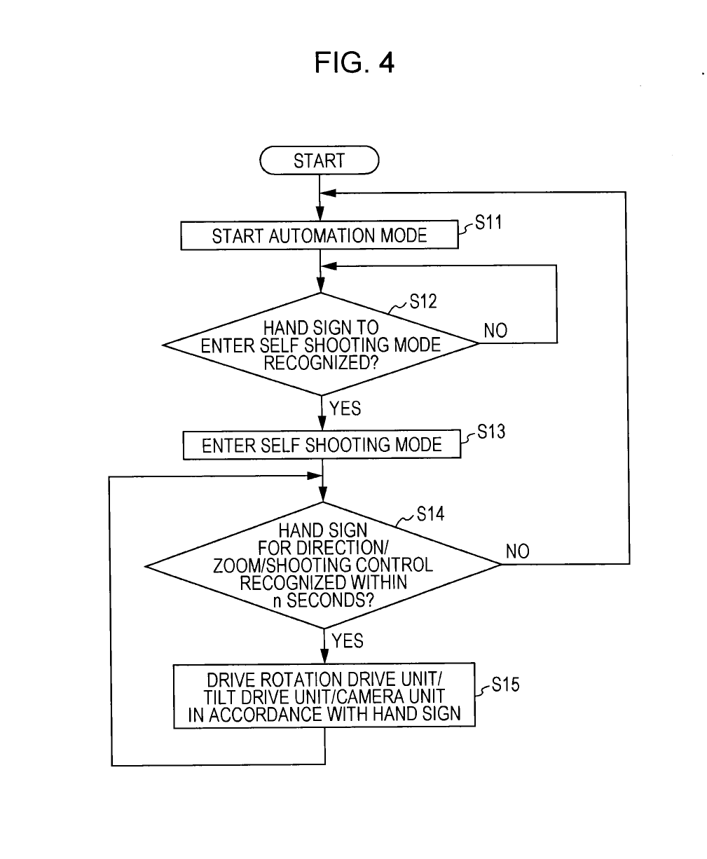

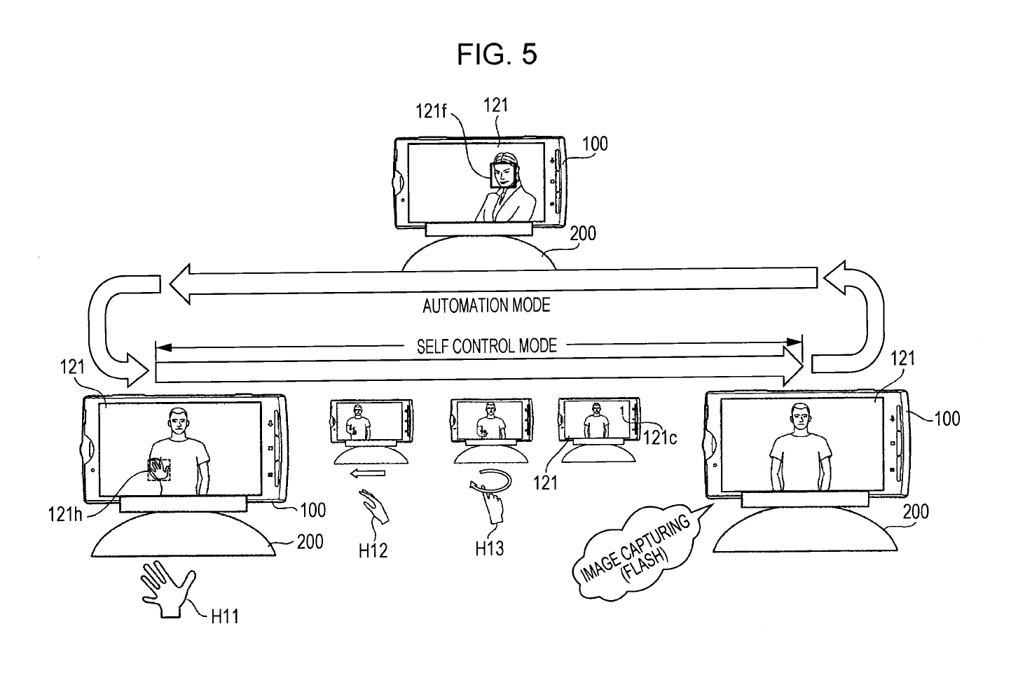

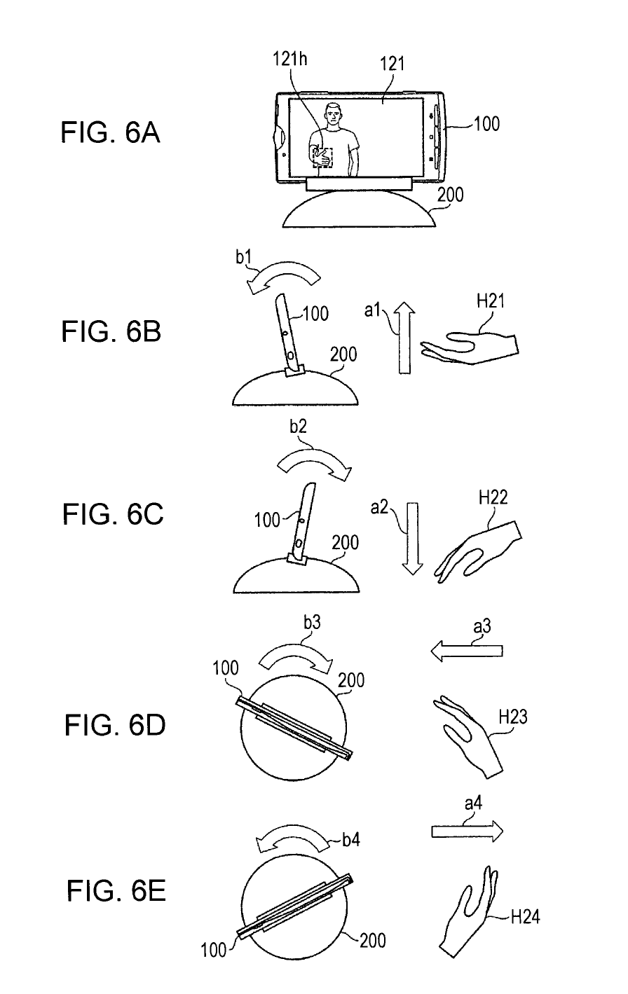

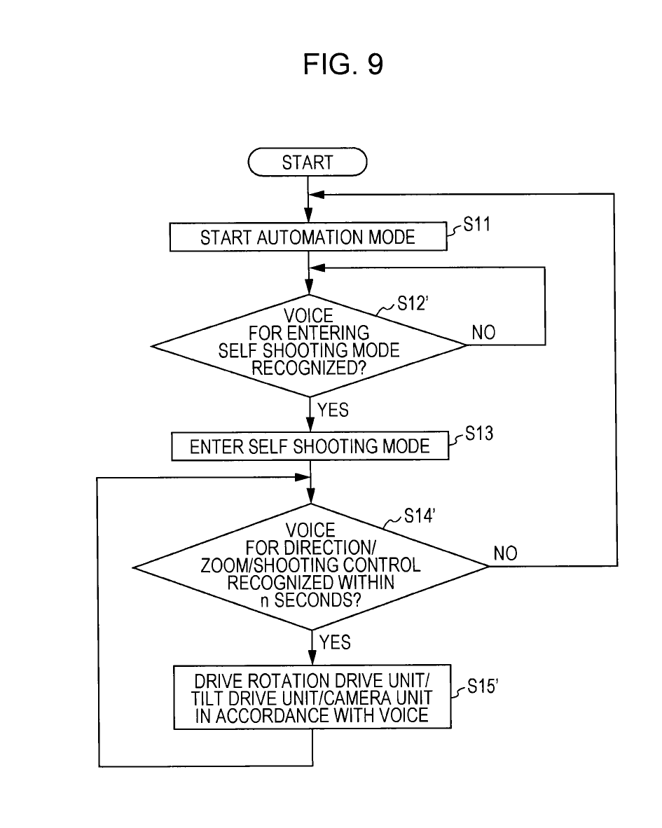

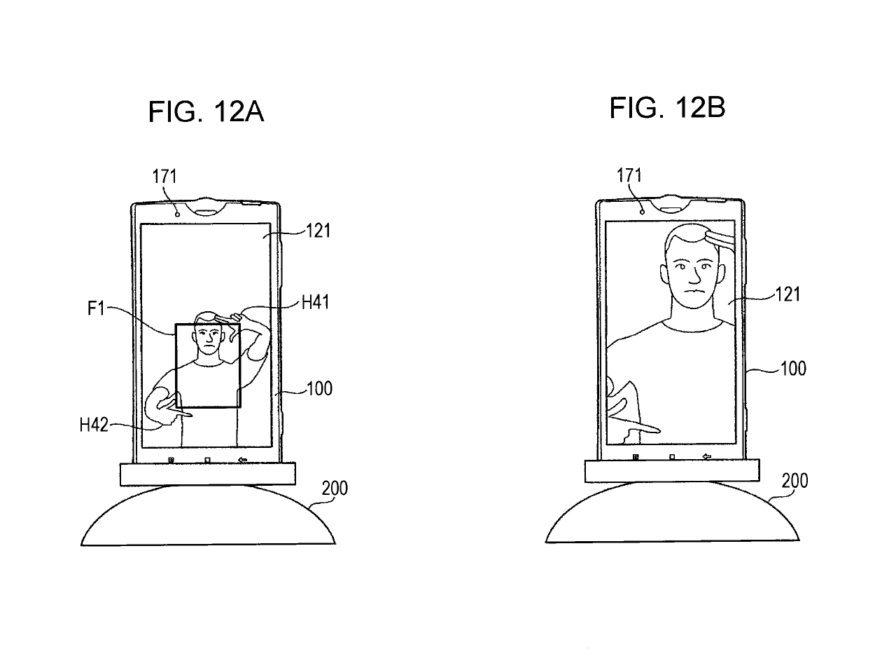

1. Configuration of terminal device (FIG. 1 to FIG. 3B)
2. Exemplary processing performed by image capturing mode and hand sign (FIG. 4 and FIG. 5)
3. Exemplary specific operations performed by hand signs (FIG. 6A to FIG. 8)
4. Exemplary modification 1: Exemplary processing performed based on voice (FIG. 9 to FIG. 11)
5. Exemplary modification 2: Example where composition is specified by both hands (FIGS. 12A and 12B)
6. Other exemplary modifications

### [1. Configuration of Terminal Device]

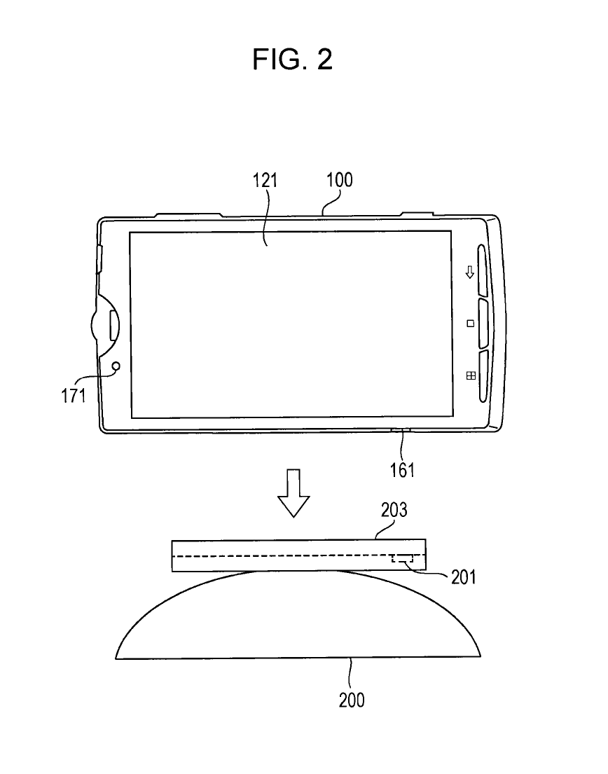

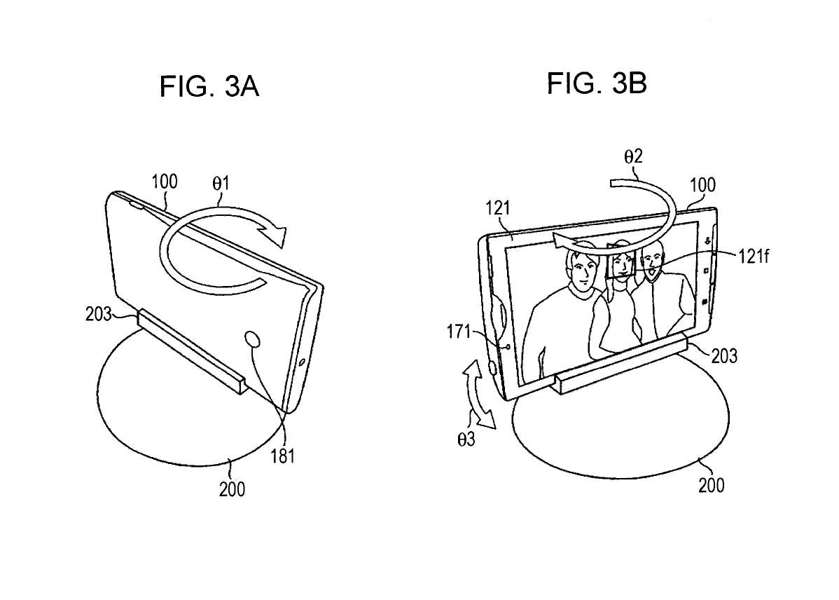

FIG. 1 is a diagram illustrating exemplary configurations of a mobile phone terminal device 100 and a camera base 200 of the present disclosure. FIG. 2 is a diagram illustrating exemplary external forms of the mobile phone terminal device 100 and the camera base 200. FIGS. 3A and 3B are diagrams illustrating examples where the camera base 200 holds the mobile phone terminal device 100.

The mobile phone terminal device 100 is an advanced terminal device referred to as a smart phone, for example, and has two built-in camera units including an in-camera unit 170 and an out-camera unit 180. The camera base 200 is a base holding a terminal device including camera units, such as the mobile phone terminal device 100. The direction and angle of elevation of the terminal device held by the camera base 200 can be changed based on instructions from the terminal device.

The mobile phone terminal device 100 includes an antenna 101 to wirelessly communicate with a base station for radio-telephone. The antenna 101 is connected to a radio communication processing unit 102. The radio communication processing unit 102 performs processing of the transmission and reception of a radio signal under control of a control unit 110. The control unit 110 transmits a control instruction to the radio communication processing unit 102 via a control line CL. The control unit 110 reads a program (software) stored in a memory 150 via the control line CL and executes the program to control each unit of the mobile phone terminal device 100. The memory 150 included in the mobile phone terminal device 100 stores prepared data, such as a program, and data generated based on a user operation. The data is stored in and read from the memory 150 under control of the control unit 110.

Voice data for conversation, which is received by the radio communication processing unit 102 at the voice conversation, is supplied to a voice processing unit 103 via a data line DL. The voice processing unit 103 performs demodulation processing on the supplied voice data to obtain an analog voice signal. The analog voice signal obtained with the voice processing unit 103 is supplied to a speaker 104, and a voice is output from the speaker 104.

Further, the voice processing unit 103 converts a voice signal output from a microphone 105 into voice data in transmission format at voice conversation. Then, the voice data converted with the voice processing unit 103 is supplied to the radio communication processing unit 102 via the data line DL. Further, the voice data supplied to the radio communication processing unit 102 is packetized and transmitted by radio.

When performing data communications or transmitting/receiving a mail via a network such as the Internet, the radio communication processing unit 102 performs processing of transmission/reception under control of the control unit 110. For example, data received by the radio communication processing unit 102 is stored in the memory 150, and processing such as display is performed based on the stored data, under control of the control unit 110. Further, the data stored in the memory 150 is supplied to the radio communication processing unit 102 and transmitted by radio. When it is necessary to abandon the data of a received mail, the control unit 110 deletes the data stored in the memory 150.

The mobile phone terminal device 100 includes a display processing unit 120. The display processing unit 120 displays video or various types of information on a display panel 121 under control of the control unit 110. The display panel includes a liquid crystal display panel, or an organic EL (Electro-Luminescence) display panel, for example.

Further, the mobile phone terminal device 100 includes a touch panel unit 130. When the surface of the display panel 121 is touched by an object including a finger, a pen, and so forth, the touch panel unit 130 detects the touched position. The touch panel unit 130 includes, for example, a capacitance touch panel.

Data of the touched position detected with the touch panel unit 130 is transmitted to the control unit 110. The control unit 110 executes a running application based on the supplied touched position.

Further, the mobile phone terminal device 100 includes an operation key 140. The operation information of the operation key 140 is transmitted to the control unit 110. Here, most of operations of the mobile phone terminal device 100 is performed through a touch panel operation achieved by using the touch panel unit 130, and the operation key 140 only performs part of the operations.

Further, the mobile phone terminal device 100 includes a short range communication processing unit 107 to which an antenna 106 is connected. The short range communication processing unit 107 performs short range communications with a nearby terminal device or access point. The short range communication processing unit 107 performs radio communications with a destination which is in a range of about several tens of meters, for example, by employing a wireless LAN (Local Area Network) system defined as IEEE 802.11 standard, etc.

Further, the mobile phone terminal device 100 has a motion sensor unit 108. The motion sensor unit 108 includes a sensor detecting the motion or orientation of the device, such as an acceleration sensor, a magnetic field sensor, etc. The acceleration sensor detects accelerations that are measured in three directions including a length, a width, and a height, for example. Data detected with the motion sensor unit 108 is supplied to the control unit 110. The control unit 110 determines the state of the mobile phone terminal device 100 based on the data supplied from the motion sensor unit 108. For example, the control unit 110 determines whether a cabinet constituting the mobile phone terminal device 100 is vertically oriented or horizontally oriented based on the data supplied from the motion sensor unit 108, and controls the orientation of an image displayed on the display panel 121.

Further, the mobile phone terminal device 100 includes an input/output processing unit 160. A terminal section 161 is connected to the input/output processing unit 160, and the input/output processing unit 160 performs input processing and output processing of data between itself and a device connected to the terminal section 161. In the example of FIG. 1, the terminal section 161 is connected to a terminal section 201 of the camera base 200. The connection between the terminal section 161 of the mobile phone terminal device 100 and the terminal section 201 of the camera base 200 is established through the direct connection between both the terminal sections 161 and 201. However, the connection between the terminal sections 161 and 201 may be established through a transmission cable.

Further, the mobile phone terminal device 100 has the two camera units including the in-camera unit 170 and the out-camera unit 180. The in-camera unit 170 is a camera unit capturing the image of an inside when a side on which the display panel 121 of the mobile phone terminal device 100 is provided is determined to be the inside. The out-camera unit 180 is a camera unit capturing the image of an outside which is a side opposite to the side on which the display panel 121 is provided. The control unit 110 performs control to switch image capturing between the image capturing performed through the in-camera unit 170 and that performed through the out-camera unit 180.

The data of images that are captured with the in-camera unit 170 and the out-camera unit 180 is supplied to an image processing unit 190. The image processing unit 190 converts the supplied image data into image data of a size (pixel number) for storage. Further, the image processing unit 190 performs processing to set the zoom state where the image of a specified range is cut from the image data captured with the camera units 170 and 180, and enlarged. The zoom processing performed through the image cutting is referred to as digital zooming. The camera units 170 and 180 may include respective zoom lenses to perform optical zooming.

Further, the image processing unit 190 performs processing to analyze the captured image, and processing to determine the details of the image. For example, the image processing unit 190 performs processing to detect the face of a person included in the image. Information about the face detected with the image processing unit 190 is supplied to the control unit 110. The control unit 110 controls the image capturing state of a range that should be brought into focus, etc. based on the supplied face information.

Further, the image processing unit 190 performs processing to detect a predetermined specific hand gesture from the image. Information about the hand gesture detected with the image processing unit 190 is supplied to the control unit 110. The control unit 110 controls the image capturing state based on the supplied hand gesture information. A specific example where the control unit 110 controls the image capturing state based on the hand gesture detection will be described later.

The in-camera unit 170 and the out-camera unit 180 capture images at uniform intervals of thirty frames per second, etc. An image captured by a running camera unit out of the in-camera unit 170 and the out-camera unit 180 is displayed on the display panel 121. Then, the control unit 110 stores in the memory 150 an image captured at the time when a shutter button operation (shooting operation) performed by a user is detected. The shooting operation is performed through the use of the touch panel unit 130, for example. Further, in the state where the camera base 200 is connected, which will be described later, the control unit 110 controls automated image capturing.

The in-camera unit 170 and the out-camera unit 180 may include a flash unit which illuminates a subject by emitting light at the shooting time when a captured image is stored in the memory 150.

Next, the configuration of the camera base 200 will be described with reference to FIG. 1.

The camera base 200 is a device provided to hold the mobile phone terminal device 100, and has the terminal section 201 connected to the terminal section 161 of the held mobile phone terminal device 100. The input/output processing unit 202 performs communications with the mobile phone terminal device 100 via the terminal section 201. Information received by the input/output processing unit 202 is supplied to a control unit 210. Further, the information supplied from the control unit 210 to the input/output processing unit 202 is transmitted from the terminal section 201 to the mobile phone terminal device 100 side.

The control unit 210 controls a rotation by a rotation drive unit 220, and controls a tilt angle formed by a tilt drive unit 230. The rotation drive unit 220 includes a motor provided to rotate the mobile phone terminal device 100 held by the camera base 200, and sets the rotation angle of the mobile phone terminal device 100 to an angle specified from the control unit 210. The tilt drive unit 230 includes a drive mechanism that makes the tilt angle of the mobile phone terminal device 100 held by the camera base 200 variable, and sets the tilt angle to an angle specified from the control unit 210.

FIG. 2 is a diagram illustrating an exemplary form of the mobile phone terminal device 100.

The mobile phone terminal device 100, which is configured as a smart phone, has the display panel 121 arranged on the surface of a vertically oriented cabinet. Note that, in FIG. 2, the mobile phone terminal device 100 placed in the horizontally oriented state is illustrated.

The lengths of diagonals of the display panel 121 are about 10 centimeters, for example. The display processing unit 120 drives the display panel 121 to produce a display thereon. Further, the touch panel unit 130 detects the touch of a finger, etc. on the surface of the display panel 121. Further, the mobile phone terminal device 100 has a lens 171 of the in-camera unit 170 (FIG. 1), which is arranged adjacent to the display panel 121. The arrangement of the lens 171 allows the in-camera unit 170 to capture an image of the side on which the display panel 121 is provided. Further, though not illustrated, the lens of the out-camera unit 180 (FIG. 1) is arranged on a face opposite to that on which the display panel 121 is provided.

Then, as illustrated in FIG. 2, the mobile phone terminal device 100 is placed on a terminal holding part 203 provided on the upper side of the camera base 200. Placing the mobile phone terminal device 100 on the terminal holding part 203 causes the terminal section 161 of the mobile phone terminal device 100 and the terminal section 201 of the camera base 200 to be connected. In the connection state, the rotation position or tilt angle of the camera base 200 is set based on instructions from the mobile phone terminal device 100.

FIGS. 3A and 3B are perspective views illustrating the state where the mobile phone terminal device 100 is held by the camera base 200. As illustrated in FIGS. 3A and 3B, the camera base 200 retains the display panel 121 of the mobile phone terminal device 100 in a nearly upright state, and rotates in horizontal directions as indicated by arrows θ1 and θ2.

Further, the tilt angle of the mobile phone terminal device 100 is variable as indicated by an arrow θ3. Here, in the state where the mobile phone terminal device 100 is held by the camera base 200 as illustrated in FIGS. 3A and 3B, the in-camera unit 170 performs image capturing, and an image captured with the in-camera unit 170 is displayed on the display panel 121. As illustrated in FIG. 3B, the lens 171 of the in-camera unit 170 and the display panel 121 are arranged on the same surface of the cabinet. Consequently, the in-camera unit 170 can capture the image of a person who is in front of the mobile phone terminal device 100, and the person who is being subjected to the image capturing can be confirmed based on an image displayed on the display panel 12, which is being captured. When the image processing unit 190 detects the person's face from the image captured with the in-camera unit 170, a frame 121f indicating the face displayed on the display panel 121 is displayed as illustrated in FIG. 3B. The lens 181 of the out-camera unit 180 is arranged on a face opposite to the face on which the display panel 121 is arranged as illustrated in FIG. 3A.

Then, when the drive mode of the camera base 200 is set to automation mode, the camera base 200 performs a horizontal rotation or moves the tilt angle until the face is detected within the image captured with the in-camera unit 170 of the mobile phone terminal device 100. Then, the control unit 110 selects a captured image including the face detected from the image captured with the in-camera unit 170, the face satisfying a given condition, as a storage image, and stores the record image in the memory 150. For example, when the control unit 110 stores a captured image in the memory 150 upon determining that a detected face is almost at the center of the image frame and the expression of the face is a smile based on an image analysis performed with the image processing unit 190.

### [2. Exemplary Processing Performed Based on Hand Signs and Image Capturing Mode]

Next, processing performed by the in-camera unit 170 that captures an image in the state where the camera base 200 holds the mobile phone terminal device 100 will be described with reference to a flowchart of FIG. 4. The image capturing with the in-camera unit 170 is controlled by the control unit 110. An image captured with the in-camera unit 170 is displayed on the display panel 121.

First, the control unit 110 starts image capturing in the automation mode (step S11). When in the automation mode, the camera base 200 performs a horizontal rotation or moves the tilt angle as required. Then, when a face is detected within a captured image after performing the horizontal rotation or moving the tilt angle, the control unit 110 executes automated image capturing in such a composition that the detected face comes into the vicinity of the center of a screen image. After performing the automated image capturing, the control unit 110 performs a horizontal rotation or changes the tilt angle, and performs processing to search for another subject.

Then, the control unit 110 determines whether or not a hand sign for entering a self shooting mode is detected from the captured image through the image analysis performed with the image processing unit 190 (step S12). Here, the hand sign denotes a sign including a predetermined shape or motion of a hand, or a combination of the shape and the motion of the hand. Specific examples of the hand sign for entering the self shooting mode will be described later. When the determination of step S12 reveals that the hand sign for entering the self shooting mode is not detected, the control unit 110 continuously performs the image capturing in the automation mode. When the hand sign for entering the self shooting mode is detected, the control unit 110 changes operation mode from the automation mode to the self shooting mode (step S13).

Upon entering the self shooting mode, the control unit 110 determines whether or not a hand sign made to control the image capturing state is detected from a captured image within predetermined n seconds after the time of entering the self shooting mode (step S14). The n seconds are a time of thirty seconds or so, for example. The hand sign made to control the image capturing state includes, for example, the following hand signs that are described in (a) to (e).

(a) a hand sign made to specify a horizontal rotation.
(b) a hand sign made to specify an increase or a decrease in the tilt angle.
(c) a hand sign made to specify zoom.
(d) a hand sign made to specify an image frame.
(e) a hand sign made to perform shooting control.

When those hand signs are not detected within the n seconds, the control unit 110 returns to the automation mode of step S11.

Then, when the above-described hand sign is detected within the n seconds, the control unit 110 issues an instruction to drive the rotation drive unit 220 or the tilt drive unit 230 in accordance with the hand sign detected with the image processing unit 190 (step S15). Further, when the hand sign detected with the image processing unit 190 is the hand sign made to perform the shooting control, the control unit 110 performs an image capturing operation specified by the hand sign. After performing the processing in accordance with the hand sign at step S15, the control unit 110 returns to step S14 to perform the hand-sign determination processing.

FIG. 5 is a diagram illustrating an exemplary change from the automation mode to the self shooting mode. In FIG. 5, the upper side indicates the time when the automation mode is selected, and the lower side indicates the time when the change to the self shooting mode occurs.

In the automation mode, for example, the mobile phone terminal device 100 placed on the camera base 200 automatically performs image capturing at the time when a person determined to be a subject is detected, as indicated in the upper side of FIG. 5. In an example of the upper side of FIG. 5, a captured image of the person is displayed on the display panel 121. The displayed image displays a frame 121f indicating that the face detection is performed. Then, the control unit 110 detects that the face included in the frame 121f is a smiling face, so that the captured image is stored in the memory 150.

Then, when the image processing unit 190 detects the hand sign 121h specifying a mode change from a captured image during the automation mode, as indicated in the lower left of FIG. 5, the control unit 110 makes a change to the self shooting mode. In this example, the image processing unit 190 detects a hand sign H11 achieved by turning a palm toward the mobile phone terminal device 100's side so that the mode set by the control unit 100 is changed to the self shooting mode. A broken line frame indicating the spot where the hand sign 121h is detected, which is included in the displayed image shown in FIG. 5, is illustrated to describe that the hand sign is being detected, and is not actually displayed in the screen image. However, it may be arranged that a displayed screen image produces a display indicating the hand-sign detection position to notify a user that the hand sign is being detected.

After changing to the self shooting mode, the control unit 110 controls the driving of the camera base 200 in accordance with the hand signs H12 and H13 that are detected with the image processing unit 190. The image processing unit 190 detects the hand sign made to perform the shooting control, which causes the control unit 110 to set the image capturing time. When the image capturing time is set, the control unit 110 produces a display 121c indicating how much time remains until the image capturing time (the second image from the right of the lower side of FIG. 5) on the display panel 121.

Then, the image of the shooting time is stored in the memory 150, as illustrated on the right end of the lower side of FIG. 5.

When the image processing unit 190 detects no hand signs over the n seconds after the image of the shooting time is stored in the memory 150, the control unit 110 resets the operation mode to the automation mode.

### [3. Exemplary Specific Operations Performed by Hand Signs]

FIGS. 6A-6E are diagrams illustrating exemplary hand signs that are made to control the driving of the camera base 200. As illustrated in FIG. 6A, a hand sign detected with the image processing unit 190 is the hand sign 121h included in an image displayed on the display panel 121.

FIG. 6B illustrates a hand sign H21 made to change the tilt angle in the + direction. The hand sign H21 is a sign given by moving a hand upward as indicated by an arrow also that the palm of the hand faces upward. The image processing unit 190 detects the hand sign H21, which causes the control unit 110 to issue the corresponding instruction to the camera base 200. Upon receiving the instruction from the control unit 110, the camera base 200 changes the tilt angle for holding the mobile phone terminal device 100 in the + direction as indicated by an arrow b1.

FIG. 6C illustrates a hand sign H22 made to change the tilt angle in the − direction. The hand sign H22 is a sign given by moving a hand downward as indicated by an arrow a2 so that the palm of the hand faces downward. The image processing unit 190 detects the hand sign H22, which causes the control unit 110 to issue the corresponding instruction to the camera base 200. Upon receiving the instruction from the control unit 110, the camera base 200 changes the tilt angle for holding the mobile phone terminal device 100 in the − direction as indicated by an arrow b2.

FIG. 6D illustrates a hand sign H23 made to change the rotation position in the left direction. The hand sign H23 is a sign given by moving a hand leftward as indicated by an arrow a3 so that the palm of the hand faces leftward. The image processing unit 190 detects the hand sign H23, which causes the control unit 110 to issue the corresponding instruction to the camera base 200. Upon receiving the instruction from the control unit, the camera base 200 changes the rotation position where the mobile phone terminal device 100 is held clockwise as indicated by an arrow b3.

FIG. 6E illustrates a hand sign H24 made to change the rotation position in the right direction. The hand sign H24 is a sign given by moving a hand rightward as indicated by an arrow a4 so that the palm of the hand faces leftward. When the image processing unit 190 detects the hand sign H24, the control unit 110 issues the corresponding instruction to the camera base 200. Upon receiving the instruction from the control unit, the camera base 200 changes the rotation position where the mobile phone terminal device 100 is held counterclockwise as indicated by an arrow b4.

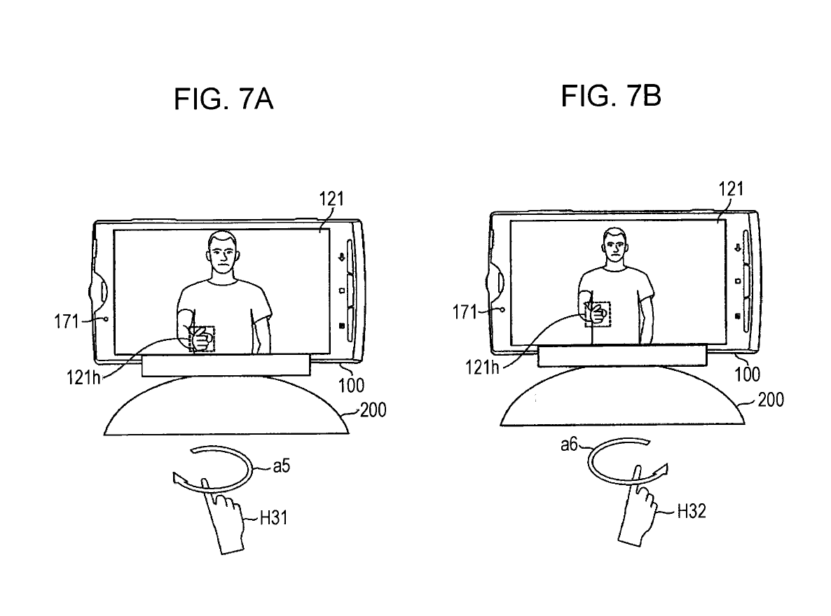

FIGS. 7A and 7B illustrate exemplary hand signs that are made to control the zoom position. FIG. 7A illustrates a zoom-in hand sign H31, and FIG. 7B illustrates a zoom-out hand sign H32.

FIG. 7A illustrates the hand sign H31 achieved by placing a single finger in an upright state and rotating the tip of the upright finger counterclockwise. The image processing unit 190 detects the hand sign H31, which causes the control unit 110 to issue a zoom-in instruction to the in-camera unit 170 or the image processing unit 190. Due to the issued zoom-in instruction, an image displayed on the display panel 121 is gradually enlarged, and an image stored at the shooting time is also correspondingly enlarged.

FIG. 7B illustrates the hand sign H32 given by placing a single finger in an upright state and rotating the tip of the upright finger clockwise. When the image processing unit 190 detects the hand sign H32, the control unit 110 issues a zoom-out instruction to the in-camera unit 170 or the image processing unit 190. Due to the issued zoom-out instruction, an image displayed on the display panel 121 is gradually reduced, and an image stored at the shooting time is also correspondingly reduced.

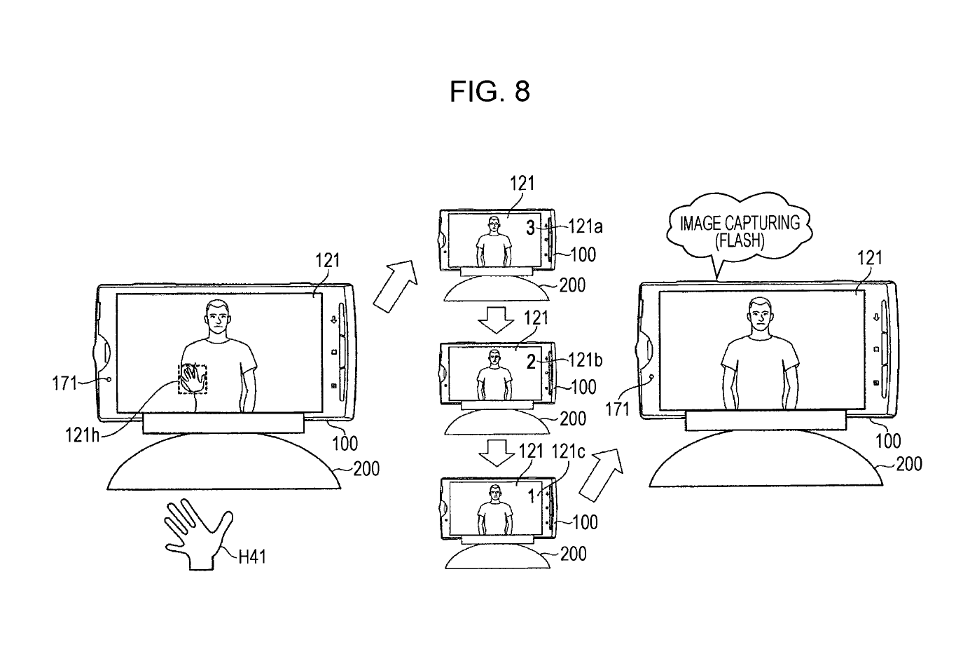

FIG. 8 illustrates an exemplary hand sign made to perform the shooting control.

First, the image processing unit 190 detects a hand sign H41 given by turning a palm toward the mobile phone terminal device 100's side as illustrated on the left end. The hand sign H41 may be equivalent to the hand sign H11 (FIG. 5) made to enter the self shooting mode. Otherwise, the hand sign H41 may be a sign given by waving a hand, etc., so that the two hand signs H11 and H41 become signs including different motions or shapes.

Then, the image processing unit 190 detects the hand sign H41, which causes the control unit 110 to set shooting time that comes three seconds later. After setting the shooting time, the control unit 110 produces displays 121a, 121b, and 121c indicating the time that elapses before the shooting time within an image displayed on the display panel 121. That is, the time display 121a displays “3” with three seconds remaining as illustrated in the center of FIG. 8. Further, the time display 121b displays “2” with two seconds remaining. Further, the time display 121c displays “1” with a second remaining.

Then, at the shooting, an image captured with the in-camera unit 170 is stored in the memory 150. At the shooting time, the mobile phone terminal device 100 outputs a shutter sound, and the flash unit emits light as necessary.

As described above, the user himself who is determined to be the subject issues an instruction to the mobile phone terminal device 100 with a hand sign, which changes the direction, the angle, the range, etc. in which the in-camera unit 170 of the mobile phone terminal device 100 performs image capturing. Consequently, the user can specify the image capturing state without touching the mobile phone terminal device 100. Further, the user himself who is determined to be the subject can specify the shooting time with a hand sign, so that the user can specify the shooting time without touching the mobile phone terminal device

Further, since the display panel 121 displays an image captured with the in-camera unit 170, the user can perform an operation while confirming the state of image capturing performed based on a hand sign, which attains an appropriate operability.

Further, when the image processing unit 190 detects no hand signs over a fixed time period in the self shooting mode, the mobile phone terminal device 100 automatically returns to the automation mode. Therefore, it becomes possible to return to the state where image capturing is automatically performed even though the user performs no particular operation, so that the image capturing can be continuously performed through the mobile phone terminal device 100.

### [4. Exemplary Modification 1: Exemplary Processing Performed Based on Voice]

The example that has hitherto been described is an example where an instruction is given by a hand sign achieved by the motion of a hand. On the other hand, it may be arranged that the mobile phone terminal device 100 analyzes a voice, and the control unit 110 performs the equivalent image capturing-state control based on the details of the voice analysis. The voice analysis is performed with, for example, the voice processing unit 103 illustrated in FIG. 1 based on a voice signal input from the microphone 105.

FIG. 9 is a flowchart illustrating exemplary control performed based on a voice. In FIG. 9, the same processing as that of the flowchart of FIG. 4 is designated by the same step number, and the description is omitted.

After the control unit 110 starts performing image capturing in the automation mode at step S11, the control unit 110 determines whether or not a voice uttered as an instruction to enter the self shooting mode is detected through the voice analysis performed with the voice processing unit 103 (step S12′). When the determination reveals that the voice uttered as the instruction to enter the self shooting mode is detected, the control unit 110 shifts to step S13, and enters the self shooting mode.

Then, after entering the self shooting mode, the control unit 110 determines whether or not the voice controlling the image capturing state is detected within the predetermined n seconds after the time of entering the self shooting mode (step S14′). When the determination reveals that the voice is detected within the n seconds, the control unit 110 issues an instruction to drive the rotation drive unit 220 or the tilt drive unit 230 in accordance with the voice detected with the voice processing unit 103 (step S15′). Further, when the voice detected with the voice processing unit 103 is a voice for the shooting control, the control unit 110 performs an image capturing operation specified by the voice for the shooting control. After performing processing in accordance with the voice at step S15′, the control unit 110 returns to the voice determination processing of step S14′.

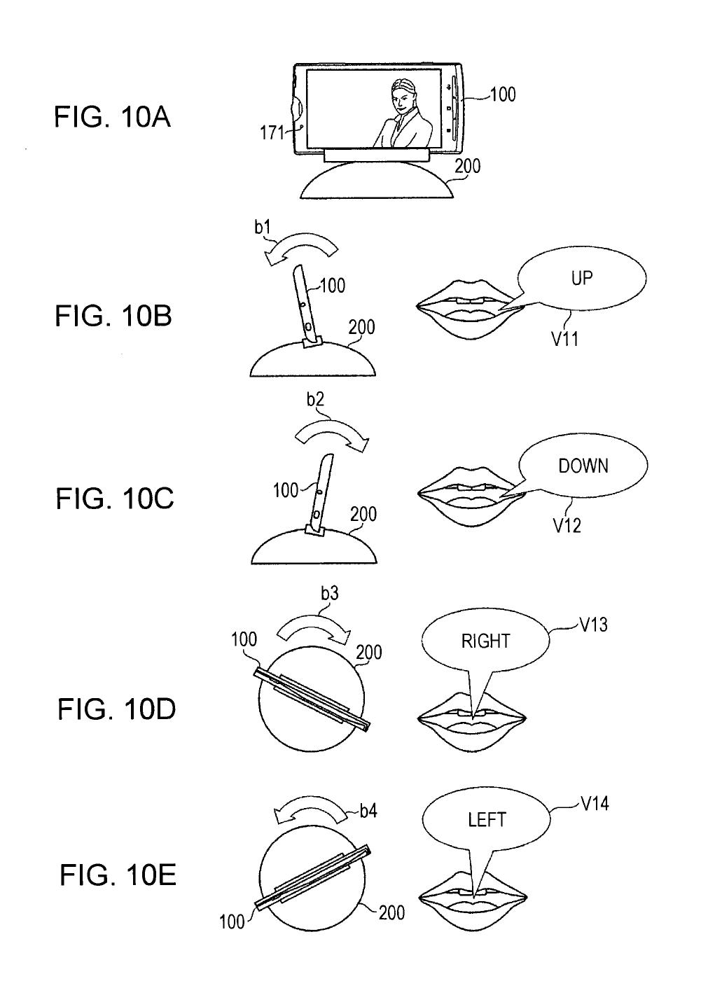

FIGS. 10A-10E are diagrams illustrating exemplary voices controlling the driving of the camera base 200. As illustrated in FIG. 10A, a voice detected with the voice processing unit 103 is a voice spoken by a subject included in an image displayed on the display panel 121 to the mobile phone terminal device 100.

FIG. 10B illustrates a voice V11 uttered to change the tilt angle in the + direction. The voice processing unit 103 detects the voice V11 saying “up”, which causes the control unit 110 to issue the corresponding instruction to the camera base 200. Due to the instruction from the control unit 110, the camera base 200 changes the tilt angle for holding the mobile phone terminal device 100 in the + direction as indicated by an arrow b1.

FIG. 10C illustrates a voice V12 uttered to change the tilt angle in the − direction. The voice processing unit 103 detects the voice V12 saying “down”, which causes the control unit 110 to issue the corresponding instruction to the camera base 200. Due to the instruction from the control unit 110, the camera base 200 changes the tilt angle for holding the mobile phone terminal device 100 in the − direction as indicated by an arrow b2.

FIG. 10D illustrates a voice V13 uttered to change the rotation position in the right direction. The voice processing unit 103 detects the voice V13 saying “right”, which causes the control unit 110 to issue the corresponding instruction to the camera base 200. Due to the instruction from the control unit 110, the rotation position of the camera base 200, where the mobile phone terminal device 100 is held, is changed counterclockwise as indicated by an arrow b3.

FIG. 10E illustrates a voice V14 uttered to change the rotation position in the left direction. The voice processing unit 103 detects the voice V14 saying “left”, which causes the control unit 110 to issue the corresponding instruction to the camera base 200. Due to the instruction from the control unit 110, the rotation position of the camera base 200, where the mobile phone terminal device 100 is held, is changed clockwise as indicated by an arrow b4.

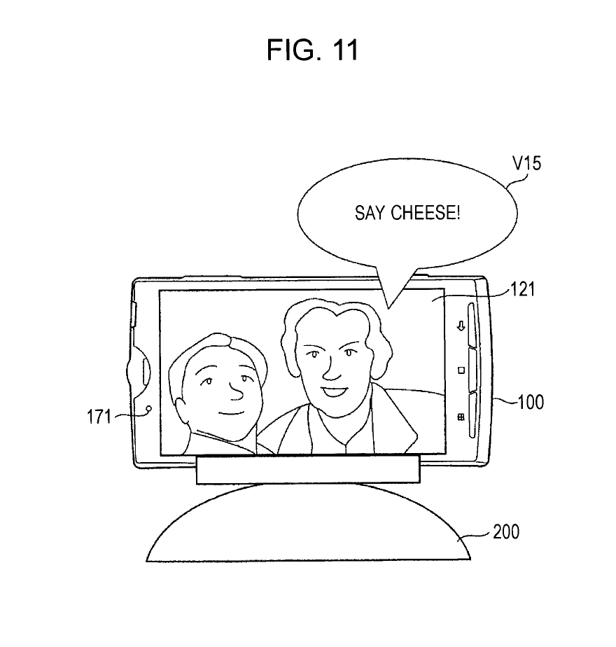

FIG. 11 is a diagram illustrating an example where the shooting time is controlled based on a voice subjected to a voice analysis.

In that case, a user determined to be a subject speaks “Say cheese!” to the mobile phone terminal device 100. The voice processing unit 103 detects the voice V14, which causes the control unit 110 to determine the time of the detection to be the shooting time, and a captured image is stored in the memory 150.

Thus, the user specifies an image capturing state by means of a voice, which allows the user to specify the image capturing state without touching the mobile phone terminal device 100 as is the case with the hand signs. It may be arranged that the voice processing unit 103 detects other operations including “zoom-in”, “zoom-out”, etc.

Further, it may be arranged that the mobile phone terminal device 100 can execute both an instruction issued by means of the hand sign and that given by means of the voice by combining the control performed based on the hand sign, which is illustrated in the flowchart of FIG. 4, and that performed based on the voice, which is illustrated in the flowchart of FIG. 9.

[5. Exemplary Modification 2: Example where Composition is Specified by Both Hands]

Further, in the examples of FIGS. 7A and 7B, the hand signs are used to specify the operations of zoom-in and zoom-out when the composition specification is performed. On the other hand, it may be arranged that the image frame is directly specified by the hands of the user.

That is, as exemplarily illustrated in FIG. 12A, two fingers of the left hand of a user determined to be a subject perform a hand sign H41 indicating the upper-right corner of the image frame, and two fingers of the right hand perform a hand sign H42 indicating the lower-left corner of the image frame.

At that time, the control unit 110 displays an image frame F1 determined by the two hand signs H41 and H42 within the display panel 121. Then, after the display panel 121 displays the image frame F1, the display panel 121 displays an image obtained by enlarging the inside of the image frame F1, as illustrated in FIG. 12B. Further, an image stored in the memory 150 at the shooting time becomes an image of the corresponding range.

Thus, the image frame is specified by the hand sign, which allows for easily cutting an arbitrary spot included in an image through an operation performed by the hands of the user.

Further, in the examples of FIGS. 12A and 12B, the vertically oriented mobile phone terminal device 100 is exemplarily held by the camera base 200. The orientation in which the mobile phone terminal device 100 is held by the camera base 200 may be either of the horizontal orientation illustrated in FIG. 3 and the vertical orientation illustrated in FIGS. 12A and 12B.

### [6. Other Exemplary Modifications]

The exemplary hand signs that are illustrated in the drawings indicate a single example, and other hand signs may be applied. Further, other operations that are not described in the above-described embodiments may be executed based on hand signs. Although the examples where the control is performed based on the hand signs that are given by the shape or the motion of a hand have been described, it is applicable to the case where a sign is given by using anything other than a hand. For example, it is applicable to the case where an instruction is issued through an operation such as moving a foot.

Further, in the above-described embodiments, the examples where the hand sign gives an instruction to take a still image are described. On the other hand, the hand sign may give an instruction to take moving images.

Further, in the above-described embodiments, the example where the connection is established between the mobile phone terminal device 100 configured as a smart phone and the camera base 200 is described. On the other hand, it may be applied to the case where the connection is established between another terminal device and a camera base. For example, it may be applied to the case where the connection is established between a terminal device configured as an electronic still camera and a camera base.

Further, in the above-described embodiments, the control unit 110 provided on the mobile phone terminal device 100's side controls the operations of the camera base 200. On the other hand, the control unit 210 provided in the camera base 200 may perform part of the control. For example, the mobile phone terminal device 100 transmits image data captured with the in-camera unit 170 to the camera base 200. Then, the control unit 210 of the camera base 200 may analyze the transmitted image data, detect a hand sign or the like, and control the rotation or the tilt angle based on the detection. For example, the image analysis processing performed to detect the hand sign may be performed with an external device other than the mobile phone terminal device 100 or the camera base 200.

Further, it may be arranged that a program (software) performing the control processing described in the flowchart of FIG. 4 or FIG. 9 is generated, and the program is stored in a storage medium. Preparing the program stored in the storage medium allows a terminal device in which the program is installed to achieve a terminal device executing the processing of the present disclosure.

The configurations and the processing that are written in the claims of the present disclosure are not limited to the examples of the above-described embodiments. It should be understood by those skilled in the art that various modifications, combinations, and other exemplary embodiments may occur depending on design and/or other factors insofar as they are within the scope of the claims or the equivalents thereof, as a matter of course.

The present disclosure may be configured as below.

(1) An information processing apparatus including: circuitry configured to acquire image data captured by an image capturing device; detect whether a hand exists in the image data; and control a state of an image capturing operation performed by the image capturing device in accordance with a command corresponding to at least one of a shape and a gesture of a hand detected in the image data.

(2) The information processing apparatus of (1), wherein the circuitry is configured to control the state of the image capturing operation performed by the image capturing device in accordance with a shape of a hand detected in the image data.

(3) The information processing apparatus of (1), wherein the circuitry is configured to control the state of the image capturing operation performed by the image capturing device in accordance with a gesture of a hand detected in the image data.

(4) The information processing apparatus of (1), wherein the circuitry is configured to control the state of the image capturing operation performed by the image capturing device in accordance with a shape and a gesture of a hand detected in the image data.

(5) The information processing apparatus of any of (1) to (4), wherein the circuitry is configured to: identify that a gesture made by a hand detected in the image data corresponds to a command to change a tilt angle of a base to which the information processing apparatus is coupled; and control outputting a command to the base instructing the base to tilt in response to the identified gesture made by the hand.

(6) The information processing apparatus of any of (1) to (5), wherein the circuitry is configured to: identify that a gesture made by a hand detected in the image data corresponds to a command to rotate a base to which the information processing apparatus is coupled; and control outputting a command to the base instructing the base to rotate in response to the identified gesture made by the hand.

(7) The information processing apparatus of any of (1) to (6), wherein the circuitry is configured to: identify that a gesture made by a hand detected in the image data corresponds to a command to change a zoom state of the image capturing device; and control the image capturing device to change a zoom state in response to the identified gesture made by the hand.

(8) The information processing apparatus of any of (1) to (7), wherein the circuitry is configured to: identify that a gesture made by a hand detected in the image data corresponds to a command to perform an image capture operation; and control the image capturing device to capture an image based on the detected gesture made by the hand.

(9) The information processing apparatus of any of (1) to (8), wherein the circuitry is configured to control the image capturing device to operate in an automatic image capture mode in which the circuitry performs processing to detect a face in the image data and automatically performs an image capturing operation upon detecting a face in the image data.

(10) The information processing apparatus of (9), wherein the circuitry is configured to control the image capturing device to exit the automatic image capture mode upon identifying that a gesture made by a hand detected in the image data corresponds to a command to exit the automatic image capture mode.

(11) The information processing apparatus of (10), wherein the circuitry is configured to control the image capturing device to return to operating in the automatic image capture mode when no command is detected in the image data for a predetermined period of time after exiting the automatic image capture mode.

(12) The information processing apparatus of any of (1) to (11), wherein the circuitry is configured to: acquire speech data captured by a sound capturing device; and control the state of an image capturing operation performed by the image capturing device in accordance with a command detected in the speech data.

(13) The information processing apparatus of any of (1) to (12), wherein the circuitry is configured to: identify that a command included in the speech data corresponds to a command to change a tilt angle of a base to which the information processing apparatus is coupled; and control outputting a command to the base instructing the base to tilt in response to the command identified in the speech data.

(14) The information processing apparatus of any of (1) to (13), wherein the circuitry is configured to: identify that a command included in the speech data corresponds to a command to rotate a base to which the information processing apparatus is coupled; and control outputting a command to the base instructing the base to rotate in response to the command identified in the speech data.

(15) The information processing apparatus of any of (1) to (14), wherein the circuitry is configured to: identify that a command included in the speech data corresponds to a command to change a zoom state of the image capturing device; and control the image capturing device to change a zoom state in response to the command identified in the speech data.

(16) The information processing apparatus of any of (1) to (15), wherein the circuitry is configured to: identify that a command included in the speech data corresponds to a command to perform an image capture operation; and control the image capturing device to capture an image based on the command identified in the speech data.

(17) A method performed by an information processing apparatus, the method comprising: acquiring image data captured by an image capturing device; detecting whether a hand exists in the image data; and controlling a state of an image capturing operation performed by the image capturing device in accordance with a command corresponding to at least one of a shape and a gesture of a hand detected in the image data.

(18) A non-transitory computer-readable medium including computer-program instructions, which when executed by an information processing apparatus, cause the information processing apparatus to: acquire image data captured by an image capturing device; detect whether a hand exists in the image data; and control a state of an image capturing operation performed by the image capturing device in accordance with a command corresponding to at least one of a shape and a gesture of a hand detected in the image data

1. An information processing apparatus comprising:
circuitry configured to
acquire image data captured by an image capturing device;
detect whether a hand exists in the image data; and
control a state of an image capturing operation performed by the image capturing device in accordance with a command corresponding to at least one of a shape and a gesture of a hand detected in the image data.

2. The information processing apparatus of claim 1, wherein
the circuitry is configured to control the state of the image capturing operation performed by the image capturing device in accordance with a shape of a hand detected in the image data.

3. The information processing apparatus of claim 1, wherein
the circuitry is configured to control the state of the image capturing operation performed by the image capturing device in accordance with a gesture of a hand detected in the image data.

4. The information processing apparatus of claim 1, wherein
the circuitry is configured to control the state of the image capturing operation performed by the image capturing device in accordance with a shape and a gesture of a hand detected in the image data.

5. The information processing apparatus of claim 1, wherein the circuitry is configured to:
identify that a gesture made by a hand detected in the image data corresponds to a command to change a tilt angle of a base to which the information processing apparatus is coupled; and
control outputting a command to the base instructing the base to tilt in response to the identified gesture made by the hand.

6. The information processing apparatus of claim 1, wherein the circuitry is configured to:
identify that a gesture made by a hand detected in the image data corresponds to a command to rotate a base to which the information processing apparatus is coupled; and
control outputting a command to the base instructing the base to rotate in response to the identified gesture made by the hand.

7. The information processing apparatus of claim 1, wherein the circuitry is configured to:
identify that a gesture made by a hand detected in the image data corresponds to a command to change a zoom state of the image capturing device; and
control the image capturing device to change a zoom state in response to the identified gesture made by the hand.

8. The information processing apparatus of claim 1, wherein the circuitry is configured to:
identify that a gesture made by a hand detected in the image data corresponds to a command to perform an image capture operation; and
control the image capturing device to capture an image based on the detected gesture made by the hand.

9. The information processing apparatus of claim 1, wherein
the circuitry is configured to control the image capturing device to operate in an automatic image capture mode in which the circuitry performs processing to detect a face in the image data and automatically performs an image capturing operation upon detecting a face in the image data.

10. The information processing apparatus of claim 9, wherein
the circuitry is configured to control the image capturing device to exit the automatic image capture mode upon identifying that a gesture made by a hand detected in the image data corresponds to a command to exit the automatic image capture mode.

11. The information processing apparatus of claim 10, wherein
the circuitry is configured to control the image capturing device to return to operating in the automatic image capture mode when no command is detected in the image data for a predetermined period of time after exiting the automatic image capture mode.

12. The information processing apparatus of claim 1, wherein the circuitry is configured to:
acquire speech data captured by a sound capturing device; and
control the state of an image capturing operation performed by the image capturing device in accordance with a command detected in the speech data.

13. The information processing apparatus of claim 12, wherein the circuitry is configured to:
identify that a command included in the speech data corresponds to a command to change a tilt angle of a base to which the information processing apparatus is coupled; and
control outputting a command to the base instructing the base to tilt in response to the command identified in the speech data.

14. The information processing apparatus of claim 12, wherein the circuitry is configured to:
identify that a command included in the speech data corresponds to a command to rotate a base to which the information processing apparatus is coupled; and
control outputting a command to the base instructing the base to rotate in response to the command identified in the speech data.

15. The information processing apparatus of claim 12, wherein the circuitry is configured to:
identify that a command included in the speech data corresponds to a command to change a zoom state of the image capturing device; and
control the image capturing device to change a zoom state in response to the command identified in the speech data.

16. The information processing apparatus of claim 12, wherein the circuitry is configured to:
identify that a command included in the speech data corresponds to a command to perform an image capture operation; and
control the image capturing device to capture an image based on the command identified in the speech data.

17. A method performed by an information processing apparatus, the method comprising:
acquiring image data captured by an image capturing device;
detecting whether a hand exists in the image data; and
controlling a state of an image capturing operation performed by the image capturing device in accordance with a command corresponding to at least one of a shape and a gesture of a hand detected in the image data.

18. A non-transitory computer-readable medium including computer-program instructions, which when executed by an information processing apparatus, cause the information processing apparatus to:
acquire image data captured by an image capturing device;
detect whether a hand exists in the image data; and
control a state of an image capturing operation performed by the image capturing device in accordance with a command corresponding to at least one of a shape and a gesture of a hand detected in the image data.
